(19) United States
(12) Patent Application Publication
(10) Pub. No.: US 2014/0365032 A1
(43) Pub. Date: Dec. 11, 2014

(54) APPARATUS, METHOD, AND SYSTEM FOR ASSISTING REMOTE PARKING

(71) Applicant: Hyundai Motor Company, Seoul (KR)

(72) Inventors: Jin Ho PARK, Hwaseong-si (KR); Kyung Soo HA, Pohang-si (KR); Joo Woong YANG, Anyang-si (KR); Young Bin KIM, Seoul (KR); Gil Won SEO, Hwaseong-si (KR)

(73) Assignee: HYUNDAI MOTOR COMPANY, Seoul (KR)

(21) Appl. No.: 14/043,182

(22) Filed: Oct. 1, 2013

(30) Foreign Application Priority Data
Jun. 5, 2013 (KR) 10-2013-0064853

(51) Int. Cl. G07C 9/00

(52) U.S. Cl. CPC G07C 9/00182
USPC 701/2

(57) ABSTRACT

An apparatus and a method for assisting remote parking includes a user authentication identifier which requests authentication information on a user when operation of a system for assisting remote parking is requested and authenticates the corresponding user based on the authentication information provided by the user. A discriminator determines whether the user gets out of the vehicle based on information acquired by a sensor installed in the vehicle when the authentication of the user is completed and outputs an operation signal when the authenticated user gets out of the vehicle. An operator operates the system for assisting remote parking in response to the operation signal.

### CROSS-REFERENCE TO RELATED APPLICATION

This application claims the benefit of priority to Korean Patent Application No. 10-2013-0064853, filed on Jun. 5, 2013 in the Korean Intellectual Property Office, the disclosure of which is incorporated herein in its entirety by reference.

### TECHNICAL FIELD

The present disclosure relates to an apparatus and a method for assisting remote parking and a system thereof, and more particularly, to a technology of operating a system for assisting remote parking of a vehicle after user authentication is completed.

### BACKGROUND

A remote control system of a vehicle is a system which allows a driver located at a remote place to operate portable terminals, such as a smart key or a smart phone without physically entering the vehicle.

According to the related art, a remote control system for assisting remote parking of the vehicle is driven by transmitting a unique authentication number embedded in an electronic fob of a smart key or hard key to a vehicle and using the unique authentication number in a vehicle.

However, when a person other than a driver, for example, a child operates a remote control system embedded smart key, a vehicle accident may occur.

### SUMMARY

The present disclosure has been made to solve the above problem in the prior art. An aspect of the present disclosure provides an apparatus and a method for assisting remote parking to improve safety by authenticating a user by confirming whether a user operating a user terminal is a pre-registered driver prior to operate a system for assisting remote parking of a vehicle.

Another aspect of the present disclosure provides an apparatus and a method for assisting remote parking to improve safety by confirming whether a driver gets out of a vehicle prior to operate a system for assisting remote parking of a vehicle.

According to an aspect of the present disclosure, an apparatus for assisting remote parking includes a user authentication identifier which requests authentication information on a user when operation of a system for assisting remote parking is requested and authenticates the user based on the information provided by the user. A discriminator determines whether the user gets out of the vehicle based on information acquired by a sensor installed in the vehicle after the user authentication is completed and outputs an operation signal when the authenticated user gets out of the vehicle. An operator operates the system for assisting remote parking in response to the operation signal.

The user authentication identifier may request the operation of a preset vehicle unit to the operator to request the user authentication information when the operation of the system for assisting remote parking is requested by a user terminal outside the vehicle.

The user authentication identifier may request the authentication information from the user terminal when the operation of the system for assisting remote parking is requested by the user terminal outside the vehicle.

The user authentication identifier may request the user authentication information through an output unit in the vehicle when the operation request of the system for assisting remote parking is input through a vehicle internal unit.

The apparatus for assisting remote parking may further include a memory in which driver information of the vehicle is stored, wherein the user authentication identifier compares the authentication information provided by the user with the driver information stored in the memory to identify.

The user authentication identifier may re-attempt the user authentication a preset number of times when the user authentication fails.

The user authentication identifier may limit the operation of the system for assisting remote parking when the user authentication fails to exceed the preset number of times.

The discriminator may generate the operation signal when the authenticated user is present within a predetermined range from the vehicle.

According to another aspect of the present disclosure, a method for assisting remote parking includes: requesting authentication information of a user when operation of a system for assisting remote parking is requested; authenticating the user by comparing the authentication information provided by the user with pre-registered driver information; determining whether the user gets out of the vehicle based on information acquired by a sensor installed in the vehicle when the user authentication is completed; generating an operation signal after confirming that the authenticated user gets out of the vehicle; and operating the system for assisting remote parking in response to the generated operation signal.

In the requesting of the authentication information, when the operation of the system for assisting remote parking is requested by a user terminal outside the vehicle, a preset vehicle unit may be operated to request the user authentication information.

The method for assisting remote parking may further include re-attempting the user authentication by a preset number of times when the user authentication fails.

The method for assisting remote parking may further include limiting the operation of the system for assisting remote parking when the re-attempted number of times of the user authentication exceeds the preset number of times.

The generating of the operation signal may further include confirming whether the authenticated user is present within a predetermined range from the vehicle, and the operation signal may be generated when the user is present within the predetermined range from the vehicle.

According to another aspect of the present disclosure, a system for assisting remote parking includes a user terminal which provides user authentication information to operate and control a system for assisting remote parking at a remote place. A vehicle authenticates a user by comparing the user authentication information input through the user terminal or an internal input unit with pre-registered driver information when operation of the system for assisting remote parking is requested from the user. After confirming that the user gets out of a driver's seat, the system operates assisting remote parking in response to the user terminal.

The user terminal may be a smart key or a portable terminal.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram showing a configuration of a system to which an apparatus of assisting remote parking according to an exemplary embodiment of the present disclosure is applied.

FIG. 2 is a block diagram illustrating a configuration of the apparatus for assisting remote parking according to an exemplary embodiment of the present disclosure.

FIGS. 3A and 3B are exemplified diagrams referenced to describe an operation of the apparatus for assisting remote parking according to an exemplary embodiment of the present disclosure.

FIG. 4 is a flow chart illustrating a method for assisting remote parking according to an exemplary embodiment of the present disclosure.

### DETAILED DESCRIPTION

Hereinafter, exemplary embodiments of the present disclosure will be described with reference to the accompanying drawings.

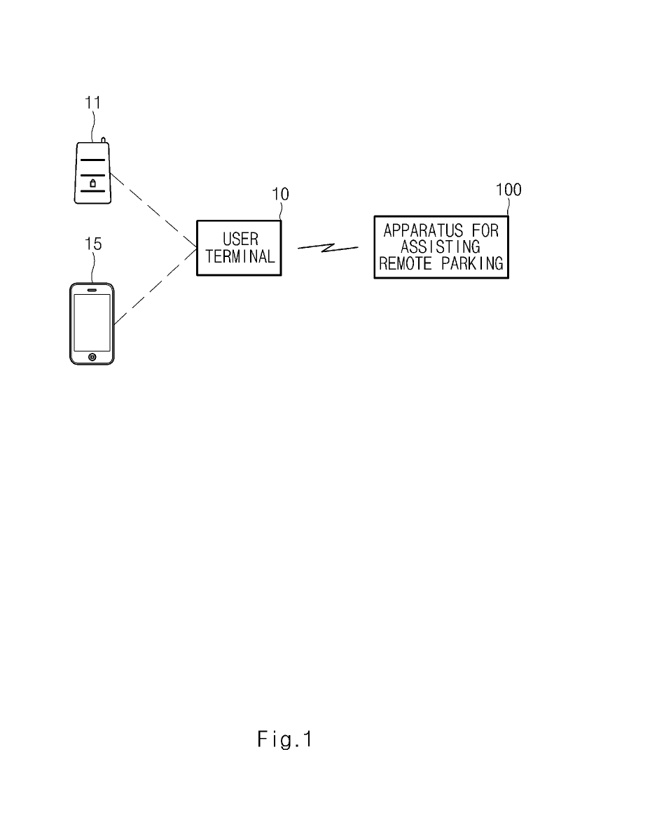

FIG. 1 is a diagram showing a configuration of a system to which an apparatus of assisting remote parking according to an exemplary embodiment of the present disclosure is applied. Referring to FIG. 1, an apparatus 100 of assisting remote parking according to an exemplary embodiment of the present disclosure is installed in a vehicle to operate a system for assisting remote parking according to an operation of a user terminal 10 located at a remote place.

In this case, the apparatus 100 of assisting remote parking authenticates a user requesting operation of the system for assisting remote parking and operates the system for assisting remote parking according to a control command received from the user terminal 10 of the authenticated user. Therefore, an authenticated user by the apparatus for assisting remote parking may park a vehicle at a remote place.

The user terminal 10 is a portable terminal including a communication interface which assists communication with a vehicle, such as a smart key 11 or a smart phone 15 and any terminal, which may input user authentication information and input a control command to a vehicle, may be used.

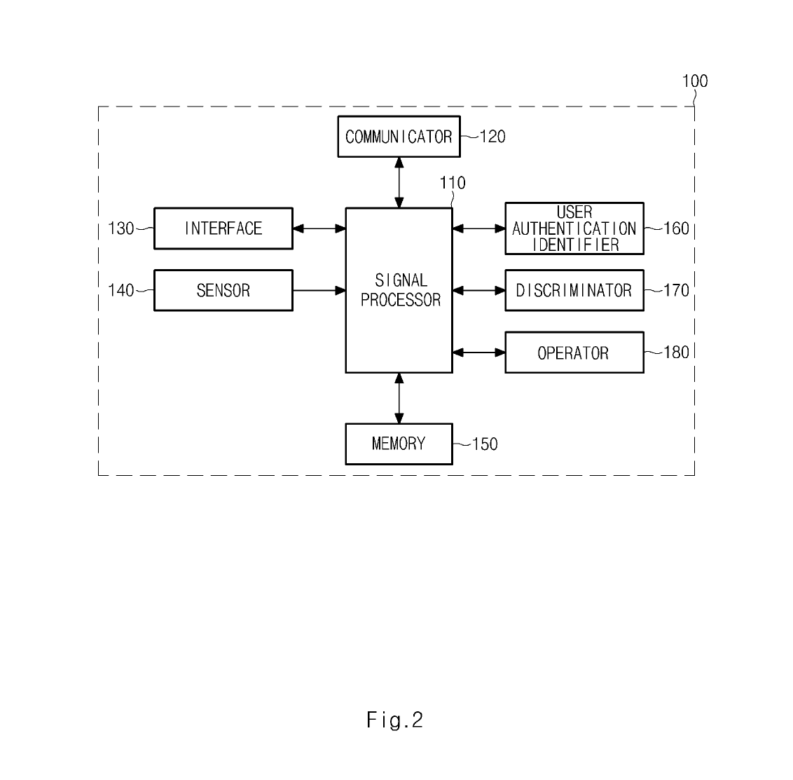

Therefore, a detailed configuration of the apparatus 100 of assisting remote parking will be described with reference to FIG. 2.

FIG. 2 is a block diagram illustrating the apparatus for assisting remote parking according to an exemplary embodiment of the present disclosure. Referring to FIG. 2, the apparatus 100 of assisting remote parking according to the exemplary embodiment of the present disclosure includes a signal processor 110, a communicator 120, an interface 130, a sensor 140, a memory 150, a user authentication identifier 160, a discriminator 170, and an operator 180. The signal processor 110 processes a signal transmitted between respective units of the apparatus for assisting remote parking.

The communicator 120 may include a communication module connected with the user terminal to assist a communication interface which may transmit and receive a signal. The communicator 120 transmits a predetermined signal generated from the apparatus for assisting remote parking to the user terminal and receives the signal transmitted from the user terminal.

The interface 130 assists an input/output function and may receive predetermined information from the user and output processing information on an operation of assisting remote parking.

The sensor 140 installed in the vehicle senses a user getting in or out, an opening or closing of a door, and the like. A sitting sensing sensor, a biometrics sensor, and the like, may be used to sense the user getting on or off a seat. A door sensor and the like may be used to sense the opening or closing of a door.

The memory 150 stores a setting value required to operate the apparatus for assisting remote parking and may store driver information for the user authentication. Further, the memory 150 may store a driving algorithm and the like to operate the system for assisting remote parking. For example, the memory 150 may store driving information to transmit a signal requesting authentication information to an external user or store a message requesting the authentication information, and the like, to an internal user.

When the operation of the system for assisting remote parking is sensed by a user, the user authentication identifier 160 requests the authentication information from the user. The authentication information is driver confirmation data for confirming whether the user requesting the operation of the system for assisting remote parking is a pre-registered driver by a password or an authentication key which is preset by a driver.

When operation of the system for assisting remote parking is requested by the user terminal outside the vehicle, the user authentication identifier 160 may output a request signal to the operator 180. Therefore, the operator 180 may operate a vehicle unit designated to transmit a signal requesting the authentication information in response to the request signal from the user authentication identifier 160. For example, the operator 180 may turn on and off an external horn, an emergency light, a lamp, and the like, for a preset number of times or a predetermined time. The user authentication identifier 160 may further transmit a request signal requesting the authentication information to the external user terminal through the communicator 120.

If the operation request of the system for assisting remote parking is received through the vehicle internal unit, the user authentication identifier 160 may request the input of the user authentication information through the interface 130. The request message may be displayed in text or output through a speaker.

The user authentication identifier 160 authenticates the corresponding user based on the authentication information provided from the user. For example, the user authentication identifier 160 may compare the user authentication information received through the external user terminal with the driver information stored in the memory 150 to authenticate the user. As another example, the user authentication identifier 160 may compare the user authentication information received through the interface 130 with the driver information stored in the memory 150 to authenticate the corresponding user.

The user authentication identifier 160 completes the user authentication when the authentication information provided from the user coincides with the driver information stored in the memory 150. In this case, the user authentication identifier 160 may inform the user that the user authentication is successful. For example, the user authentication identifier 160 may also output an authentication success message through the user terminal or an output unit. Further, the user authentication identifier 160 outputs the user authentication success information to the operator 180. The operator 180 may drive the vehicle in response to the user authentication success information.

When the authentication information provided from the user does not coincide with the driver information stored in the memory 150, the user authentication identifier 160 requests the authentication information again from the user. The user may re-attempt the user authentication a preset number of times. When the user authentication fails to exceed the predetermined number of times, the user authentication identifier 160 may limit the operation of the system for assisting remote parking.

The discriminator 170 determines the user getting in and out a vehicle based on the information obtained by at least one sensor 140 included in the vehicle when the user authentication is completed by the user authentication identifier 160. As an example, the discriminator 170 confirms whether the user is seated on a driver's seat based on the information acquired through a sitting sensing sensor or a biometrics sensor to discriminate the getting in or out of the user. In this case, even though the user is in the getting out state or the getting in state, the discriminator 170 may output the operation signal to the operator 180 when the user gets out of a vehicle within a predetermined time.

The discriminator 170 discriminates whether the authorized user is located within a predetermined range from a vehicle prior to outputting the operation signal. If the user is within a predetermined range from the vehicle, the discriminator 170 may output the operation signal.

The operator 180 operates the system for assisting remote parking in response to the operation signal from the discriminator 170 and based on the control signal received from the user terminal.

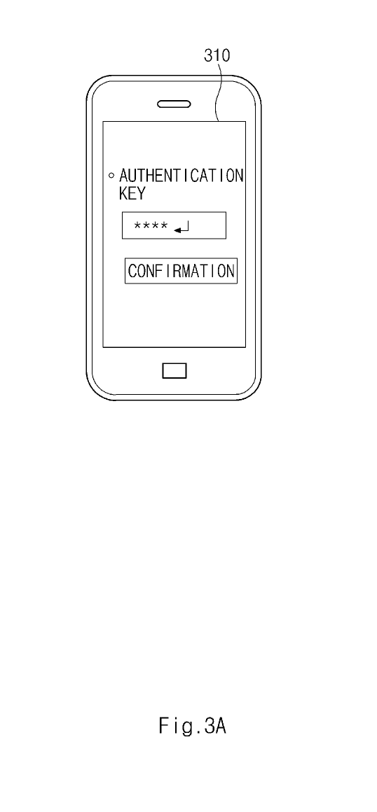

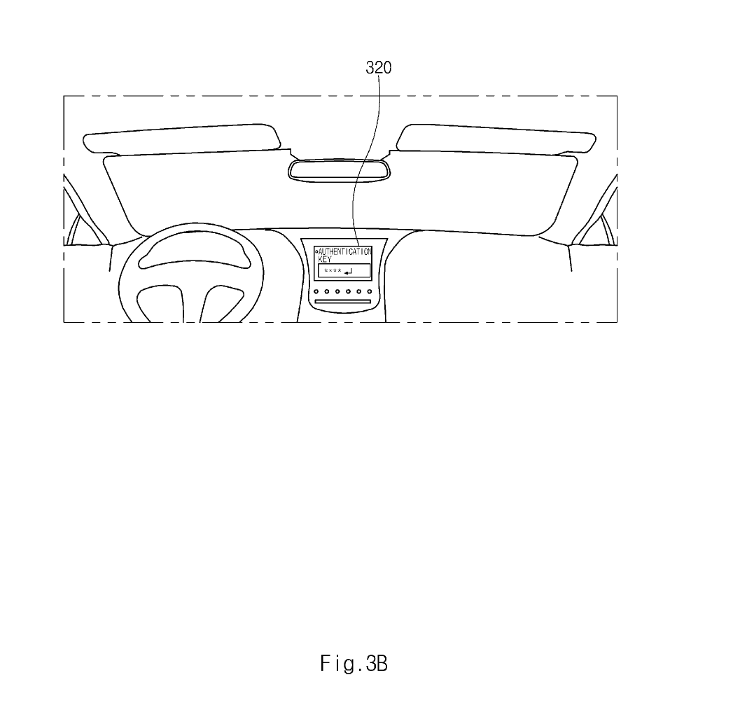

FIGS. 3A and 3B are exemplified diagrams referenced to describe an operation of the apparatus for assisting remote parking according to an exemplary embodiment of the present disclosure.

FIG. 3A illustrates inputting authentication information through the user terminal. When the authentication information request of the user is present for assisting remote parking, the user may input the user authentication information through a screen 310 of the user terminal and transmit the input authentication information to the apparatus for assisting remote parking.

FIG. 3B illustrates inputting authentication information through the input/output unit in a vehicle. The apparatus for assisting remote parking requests the input of the authentication information through the output unit when operation of the system for assisting remote parking in a vehicle is requested. The user may input the authentication information through the input unit 320 in response to the request of the apparatus for assisting remote parking.

Therefore, the apparatus for assisting remote parking compares the authentication information received from the user terminal as illustrated in FIG. 3A or the authentication information input as illustrated in FIG. 3B with the pre-stored driver information to authenticate the user according to whether the authentication information coincides with the driver information.

A method for assisting remote parking according to an exemplary embodiment of the present disclosure as described above will be described below in detail.

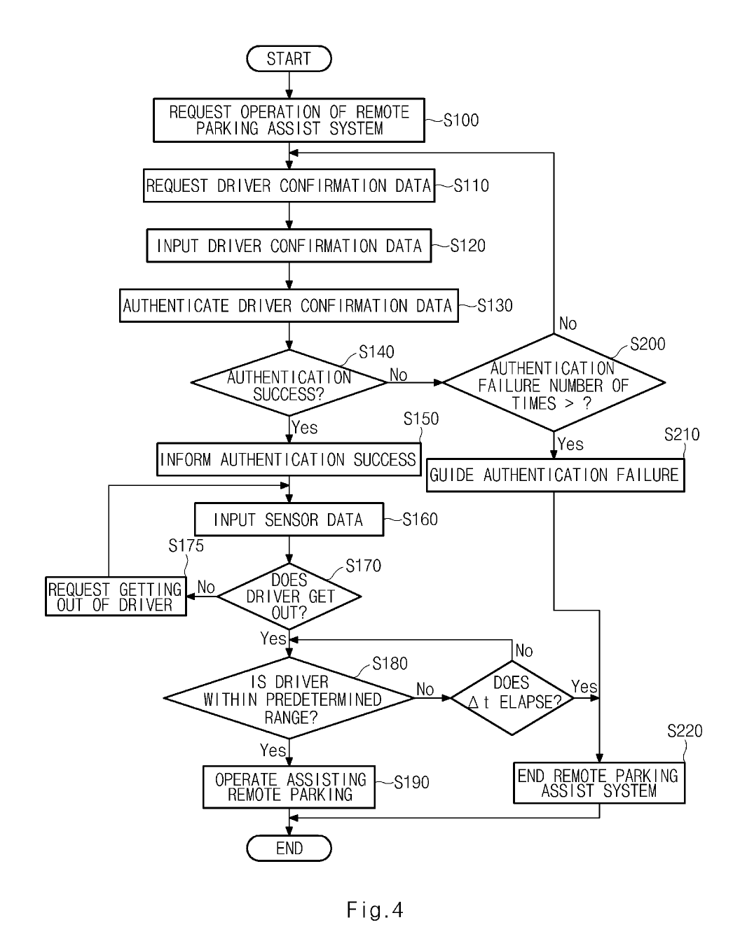

FIG. 4 is a flow chart illustrating a method for assisting remote parking according to an exemplary embodiment of the present disclosure. Referring to FIG. 4, when the operation of the system for assisting remote parking is requested (S100), the apparatus for assisting remote parking according to an exemplary embodiment of the present disclosure requests the authentication information from the user, that is, the driver confirmation data (S110).

When the driver confirmation data is input from a user through the user terminal or the input unit in a vehicle (S120), the apparatus for assisting remote parking authenticates the driver confirmation data by comparing the driver confirmation data input during the ‘S120’ process with the pre-registered driver information (S130).

When the authentication fails at S130, the apparatus for assisting remote parking may repeatedly process from the ‘S110’ to ‘S140’ until the authentication failure number of times exceeds a reference value a. When the authentication failure number of times exceeds the reference value a (S200), the apparatus for assisting remote parking informs the user that the authentication fails (S210) and ends the system for assisting remote parking (S220).

On the other hand, if the authentication is successful (S140), the apparatus for assisting remote parking informs a user that the authentication is successful (S150). In this case, the apparatus for assisting remote parking may output the authentication success message through the user terminal or the output unit in a vehicle.

The apparatus for assisting remote parking receives sensor data from at least one sensor installed in a vehicle (S160) to discriminate whether the driver gets out of a vehicle (S170). If the driver does not get out of a vehicle according to S170, the apparatus for assisting remote parking may request the driver get out the vehicle (S175).

Once the apparatus for assisting remote parking confirms that the driver gets out of a vehicle, the apparatus for assisting remote parking determines whether the driver is present within a predetermined range from the vehicle (S180) to operate assisting remote parking (S190). Meanwhile, if the driver is not present in the predetermined range for the preset time (S185), the system for assisting remote parking may end (S220).

As set forth above, according to an exemplary embodiment of the present disclosure, operating the system for assisting remote parking can improve safety by confirming whether the user operating the user terminal is a pre-registered driver prior to operate the system for assisting remote parking of a vehicle. The system for assisting remote parking is operated after confirming whether a driver gets out of a vehicle prior to operate the system, thereby increasing safety.

Although the apparatus and the method for acquiring a differential image according to an exemplary embodiment of the present disclosure have been described with reference to the accompanying drawings, the present disclosure is not limited to the embodiments and the accompanying drawings disclosed in the present specification, but may be modified without departing from the scope and spirit of the present disclosure.

What is claimed is:

1. An apparatus for assisting remote parking, comprising:
a user authentication identifier which requests authentication information of a user when operation a system for assisting remote parking is requested and authenticates the user based on the authentication information;
a discriminator which determines whether the user gets out of the vehicle based on information acquired by a sensor installed in the vehicle after the user authentication is completed and outputs an operation signal when the authenticated user gets out of the vehicle; and
an operator which operates the system for assisting remote parking in response to the operation signal.

2. The apparatus of claim 1, wherein the user authentication identifier requests the operation of a preset vehicle unit to the operator to request the user authentication information when the operation of the system for assisting remote parking is requested by a user terminal outside the vehicle.

3. The apparatus of claim 1, wherein the user authentication identifier requests the authentication information from the user terminal when the operation of the system for assisting remote parking is requested by the user terminal outside the vehicle.

4. The apparatus of claim 1, wherein the user authentication identifier inputs the user authentication information through an output unit in the vehicle when the operation request of the system for assisting remote parking is input through a vehicle internal unit.

5. The apparatus of claim 1, further comprising:
a memory in which driver information of the vehicle is stored,
wherein the user authentication identifier compares the authentication information provided by the user with the driver information stored in the memory to perform the user authentication.

6. The apparatus of claim 1, wherein the user authentication identifier re-attempts the user authentication by a preset number of times when the user authentication fails.

7. The apparatus of claim 1, wherein the user authentication identifier limits the operation of the system for assisting remote parking when the user authentication fails to exceed the preset number of times.

8. The apparatus of claim 1, wherein the discriminator generates the operation signal when the authenticated user is present within a predetermined range from the vehicle.

9. A method for assisting remote parking, comprising:
requesting authentication information on a user when operation a system for assisting remote parking is requested;
authenticating the corresponding user by comparing the authentication information provided by the user with pre-registered driver information;
determining whether the user gets out of the vehicle based on information acquired by a sensor installed in the vehicle when the user authentication is completed;
generating an operation signal after confirming that the authenticated user gets out of the vehicle; and
operating the system for assisting remote parking in response to the generated operation signal.

10. The method of claim 9, wherein in the requesting of the authentication information, when the operation of the system for assisting remote parking is requested by a user terminal outside the vehicle, a preset vehicle unit is operated so as to request the user authentication information.

11. The method of claim 9, further comprising:
re-attempting the user authentication a preset number of times when the user authentication fails, while authenticating the user.

12. The method of claim 11, further comprising:
limiting the operation of the system for assisting remote parking when the re-attempted number of times of user authentication exceeds the preset number of times.

13. The method of claim 9, wherein the generating of the operation signal includes confirming whether the authenticated user is present within a predetermined range from the vehicle, and
the operation signal is generated when the user is present within the predetermined range from the vehicle.

14. A system for assisting remote parking, comprising:
a user terminal which provides user authentication information to operate and control the system for assisting remote parking at a remote place; and
a vehicle which authenticates a user by comparing the user authentication information input through the user terminal or an internal input unit with pre-registered driver information when operation of the system for assisting remote parking is requested from the user, and after confirming that the user gets out of a driver's seat, operating assisting remote parking in response to the user terminal.

15. The system of claim 14, wherein the user terminal is a smart key or a portable terminal.
